(19) United States
(12) Patent Application Publication
(10) Pub. No.: US 2004/0028889 A1
(43) Pub. Date: Feb. 12, 2004

(54) Resin-molded product and method of molding the same

(75) Inventor: Takashi Arai, Ibaraki (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 10/634,861

(22) Filed: Aug. 6, 2003

(30) Foreign Application Priority Data
Aug. 7, 2002 (JP) 2002-230325

(51) Int. Cl. B32B 7/02

(52) U.S. Cl. 428/304.4

(57) ABSTRACT

It is an object of this invention to prevent warp and deformation caused by a shrinkage difference when a resin part having a large thickness difference is molded. To achieve this object, in a resin-molded product having a thick portion and thin portion, the thick portion is a foamed body.

### FIELD OF THE INVENTION

The present invention relates to a resin-molded product having a thick portion and thin portion, and a method of molding the same.

### BACKGROUND OF THE INVENTION

As shown in FIG. 17, a conventional resin-molded product having a large thickness difference is obtained by forming a thick portion as a rib or partially recessing the thick portion, in order to decrease the thickness difference. If it is unavoidable to form a thick portion because the portion has the function of a shaft or the like, a gas is injected into this thick portion to make a sink, as shown in FIG. 18, thereby reducing the thickness.

In addition, Japanese Patent Laid-Open No. 2002-36280 discloses a method in which carbon dioxide is saturated into a molten resin material, and a mold cavity is also pressurized by the carbon dioxide. After a resin is charged in a thin portion, the internal gas pressure of the cavity is lowered to foam a thick portion.

Each method can prevent a sink mark in the thick portion. However, if a thickness difference is large, especially when a thick portion is few times as thick as a thin portion or more, neither method can eliminate warp and deformation resulting from the shrinkage difference between the thin and thick portions.

### SUMMARY OF THE INVENTION

The present invention has been made in consideration of the above problem, and has as its object to prevent warp and deformation caused by a shrinkage difference when a resin product having a large thickness difference is molded.

To solve the above problem and achieve the above object, according to a first aspect of the present invention, there is provided a resin-molded product having a thick portion and thin portion, wherein the thick portion is a foamed body.

According to a second aspect of the present invention, there is provided a resin-molded product preparing method of preparing a resin-molded product having a thick portion and thin portion, wherein after an inert gas is allowed to saturate into a-resin material, the resin material is injected, for a charging time of 1sec or less, into a metal mold at a temperature lower by 5° C. to 25° C. than a heat deformation temperature of the resin material before the inert gas saturation, and the resin material is extracted from the mold after being foamed and hardened in the mold.

According to a third aspect of the present invention, there is provided a resin-molded product preparing method of preparing a resin-molded product having a thick portion and thin portion, wherein after an inert gas is allowed to saturate into a resin material, the resin material is injected into a metal mold in which a mold portion for molding the thin portion has a thermal conductivity of 0.15 to 8.5 W/m·K, and the resin material is molded in the metal mold.

According to a fourth aspect of the present invention, there is provided a resin-molded product preparing method of preparing a resin-molded product having a thick portion and thin portion, wherein after an inert gas is allowed to saturate into a resin material, the resin material is charged into a metal mold, and a holding pressure of 80 to 200 Mpa is applied for 0.1 to 1 sec.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a view showing the shape of a molded product as the first example according to an embodiment of the present invention;

FIG. 2 is a front view of a product molded by a conventional method;

FIG. 3 is a top view of the product molded by the conventional method;

FIG. 4 is a side sectional view of the molded product shown in FIG. 1;

FIG. 5 is a view showing the mold shape of the embodiment of the present invention;

FIG. 6 is a graph showing changes in temperature of a molded product in a mold according to a conventional method;

FIG. 7 is a graph showing changes in temperature of a molded product according to a method of the embodiment of the present invention;

FIG. 8 is a view showing the arrangement of a molding apparatus of the embodiment;

FIG. 9 is a view showing another example of the arrangement of the molding apparatus of the embodiment;

FIG. 10 is a view showing still another example of the arrangement of the molding apparatus of the embodiment;

FIG. 11 is a view showing still another example of the arrangement of the molding apparatus of the embodiment;

FIG. 12 is a sectional view of a mold piece of the embodiment;

FIG. 13 is a view showing the shape of a molded product as the second example according to the embodiment;

FIG. 14 is a view showing the shape of a molded product as the third example according to the embodiment;

FIG. 15 is a view showing the shape of a molded product as the fourth example according to the embodiment;

FIG. 16 is a view showing the shape of a molded product as the fifth example according to the embodiment;

FIG. 17 is a view showing the shape of a conventional molded product;

FIG. 18 is a view showing the shape of a conventional molded product;

FIG. 19 is a table showing the results of warp deformation according to a conventional molding method;

FIG. 20 is a table showing the results of warp deformation according to the embodiment of the present invention; and

FIG. 21 is a table showing the results of warp deformation according to the embodiment of the present invention.

### DETAILED DESCRIPTION OF THE PREFERRED EMBODIMENT

A preferred embodiment of the present invention will now be described in detail in accordance with the accompanying drawings.

First, an outline of the embodiment will be explained.

In this embodiment, a foaming agent such as an inert gas is allowed to saturate into a resin material in advance. When this foaming agent is allowed to saturation, the resin material is in a molten state or in the form of pellets. As an inert gas as the foaming agent, nitrogen, carbon dioxide, or argon gas is used. The resin material into which the foaming agent saturates is charged, in the molten state, into a metal mold having a predetermined shape as rapid as possible by using an injection molding machine or extruder. A higher injection rate is more effective because the amount of skin layer formed by cooling while the resin is flowing reduces. However, this injection rate depends upon the viscosity of the resin material and the capability of the injection molding machine or extruder. The present inventors made extensive studies and decided to complete charging of the resin material for 0.1 to 1 sec. A pressure necessary to charge the resin was found to be 80 to 200 Mpa. In molding a large-sized part, the number of gates must be increased so that charging is complete within the charging time of this embodiment.

After the resin material is injected into the mold, a holding pressure of 80 to 200 Mpa is applied for 0.1 to 1 sec where necessary. This holding pressure is raised as a thickness difference increases and warp deformation caused by a shrinkage difference increases. In normal foam molding, negative pressure molding is sometimes performed, in order to increase the foaming magnification, by increasing the mold volume after a resin material is injected into the mold, without applying any holding pressure. In this embodiment, however, as will be explained later, the holding pressure is essential except when the material of a mold is changed and a thick portion is about two to three times as thick as a thin portion. By applying the dwell pressure for a short time period, the internal pressure difference between a thin portion and a thick portion is increased, thereby increasing the density of the thick portion in which the internal pressure is high.

In addition, in this embodiment, a foaming agent which saturate into a resin functions to increase the size of a thick portion, i.e., decrease the shrinkage amount of the thick portion by the foaming force during holding and even after holding is complete. Usually, the shrinkage amount of a thick portion is larger than that of a thin portion, so warp and deformation are caused by the shrinkage difference. In this embodiment, however, the shrinkage amount of a thick portion can be made close to that of a thin portion by raising the density of the thick portion. As a consequence, this embodiment can eliminate warp and deformation caused by the shrinkage difference.

Furthermore, in this embodiment, the thermal conductivity of a mold member corresponding to a thin portion is made different from that of a mold member corresponding to a thick portion. This makes it possible to approach the cooling/hardening timing of the thin portion to that of the thick portion and make the shrinkage amounts of these portions close to each other, thereby reducing the warp deformation amount. The cooling/hardening start timing of a thin portion is delayed by using a material having low thermal conductivity, e.g., a resin heat-insulating layer, ceramics, or porous metal, in this thin portion. In addition, the crystallization time of a crystalline resin material is prolonged to make the shrinkage amount of this thin portion larger than that in normal molding, thereby approaching this shrinkage amount to that of a thick portion. Also, the cooling/hardening start timing of the thick portion is advanced by using a material having high thermal conductivity, e.g., a copper alloy or aluminum alloy, in this thick portion, thereby approaching this cooling/hardening start timing of the thick portion to that of the thin portion. In this manner, warp deformation caused by the shrinkage difference can be eliminated.

The embodiment of the present invention will be described in more detail below.

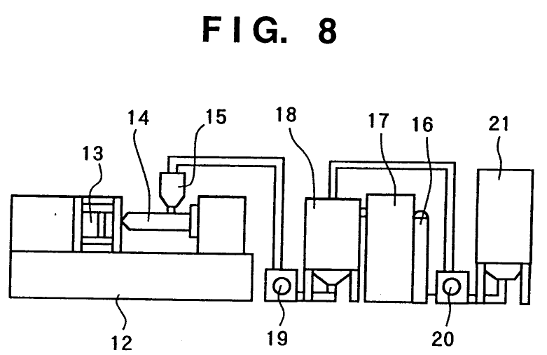

FIGS. 8 to 11 illustrate an apparatus according to the embodiment of the present invention, which allows a foaming material to permeate into a resin material.

In FIG. 8, reference numeral 12 denotes an injection molding machine; 13, a metal mold; 14, a plasticator; 15, a hopper; 16, a gas cylinder; 17, a gas pressurizing device; 18, a gas saturation vessel; 19 and 20, pump; and 21, a material silo.

A process of allowing a gas as a foaming material to saturate into a resin material will be explained below with reference to FIG. 8.

A pelletized resin material is stored in the silo 21. When molding is to be performed, a predetermined amount of the resin material is supplied to the gas saturation vessel 18 by the pump 20. A gas as a foaming material is supplied from the gas cylinder 16 to the gas saturation vessel 18 after pressurized by the gas pressurizing device 17. The gas saturates into the resin material in the gas saturation vessel 18. This resin material into which the gas saturates is supplied to the hopper 15 by the pump 19. The resin in the hopper 15 is plasticized and kneaded by the plasticator 14, and charged into a cavity formed in the metal mold 13 and having a desired shape. The resin into which the gas as a foaming material saturates starts foaming at the same time the resin is injected into the mold. After cooling, the mold is opened, and the molded product is extracted.

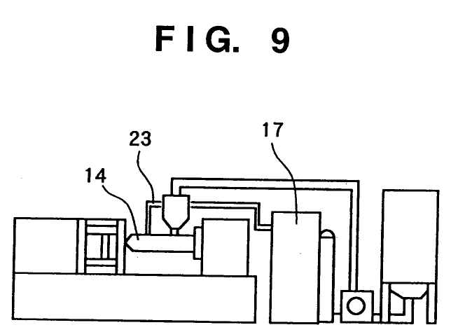

FIG. 9 is an apparatus which directly supplies a gas as a foaming material to a plasticator of an injection molding machine. In FIG. 9, reference numeral 14 denotes a plasticator; and 17, a gas pressurizing device. A gas as a foaming material pressurized by the gas pressurizing device 17 is introduced into the plasticator 14 by a pipe 23, kneaded together with a resin material in a molten state, and saturates into the resin material. After that, the resin material is charged into the mold to obtain a molded product.

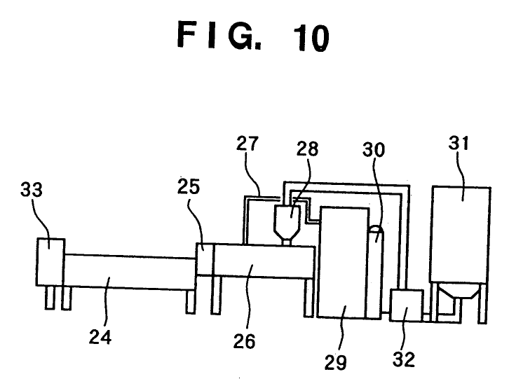

FIG. 10 shows an example using an extruder.

Referring to FIG. 10, as in FIG. 9, a gas as a foaming material is pressurized by a pressurizing device 29, and supplied to a plasticator 26 of the extruder through a pipe 27. This gas is kneaded together with a molten resin. The resin material into which the gas saturates is supplied through a dice 25, cooled by a water cooling device 24, and fed by a feeder 33.

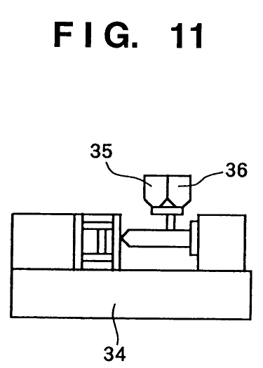

FIG. 11 shows an apparatus in which a foaming material and resin material are mixed in hoppers and injection-molded. In FIG. 11, reference numeral 35 denotes a hopper containing a foaming material; and 36, a hopper containing a resin material. The two materials are mixed and molded by an injection molding machine 34.

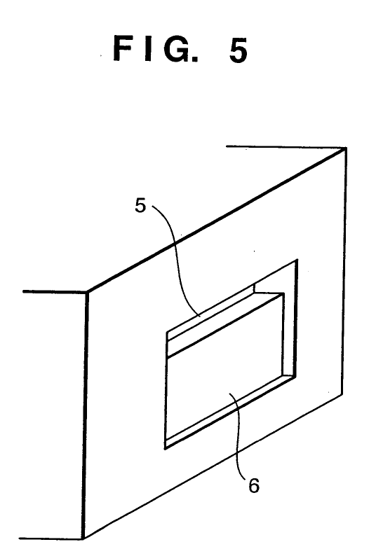

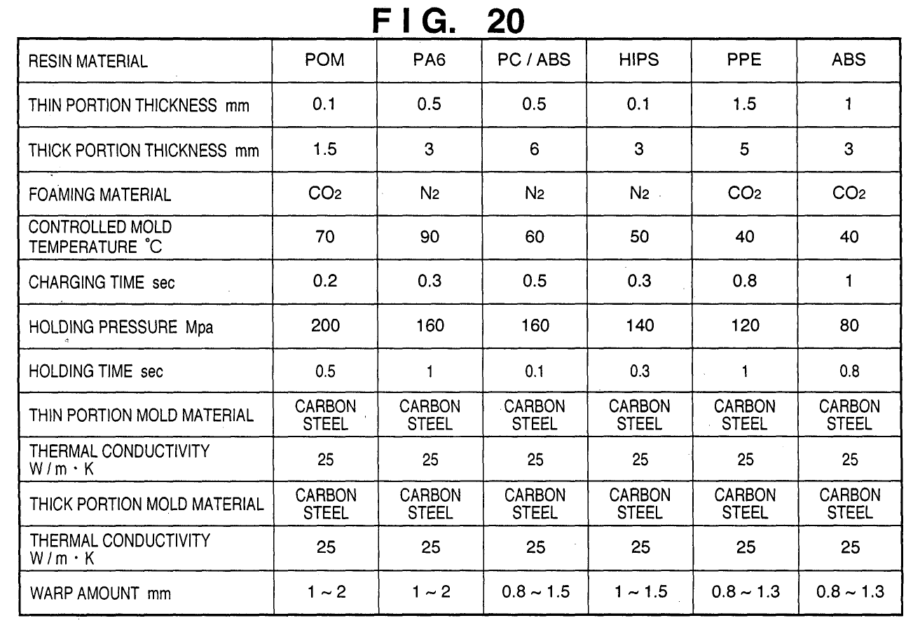

FIG. 5 shows a metal mold of this embodiment. In FIG. 5, reference numeral 6 denotes a core corresponding to a thin portion; and 5, a core corresponding to a thick portion. Each core is detachable, and a mold member shown in FIG. 20 is appropriately used.

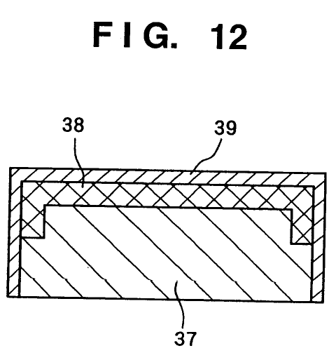

FIG. 12 shows the core section of the mold of this embodiment. Reference numeral 37 denotes a steel member; 38, a resin film formed by vapor deposition polymerization; and 39, a hard film. More specifically, carbon steel such as S55C or stainless steel such as SUS304 was used as the steel member, polyimide or ethylene tetrafluoride was used as the resin layer, and chromium, nickel, or titanium nitride was used as the hard layer.

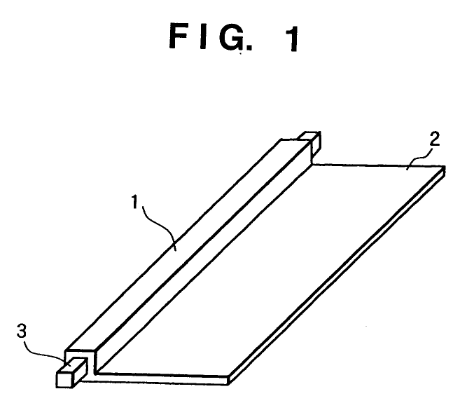

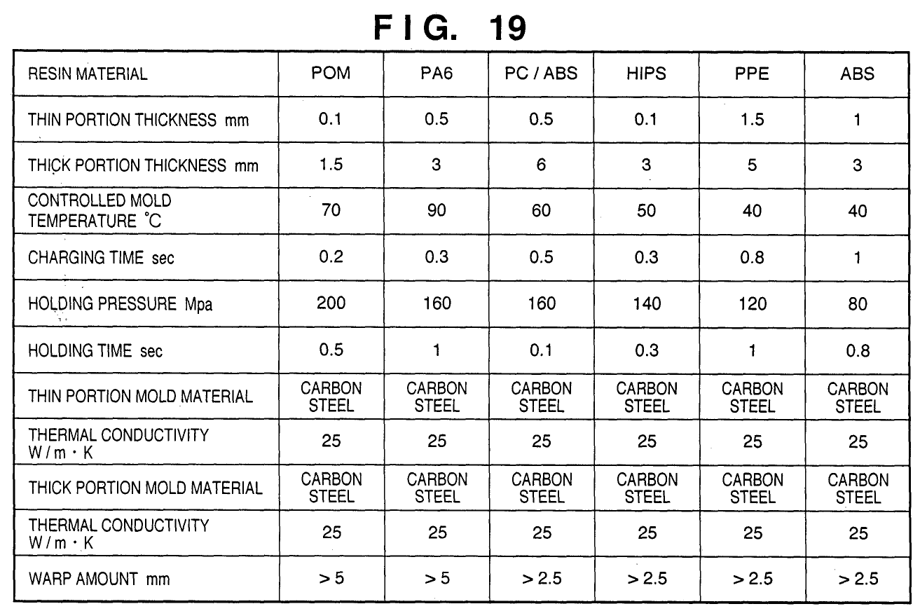

FIG. 1 shows the shape of a molded product of the first example of this embodiment. In FIG. 1, reference numeral 1 denotes a thick portion; 2, a thin portion; and 3, bearing portions. The thickness of each of the thick portion 1 and thin portion 2 can be changed by replacing the mold piece of the metal mold. FIG. 19 shows the results of warp deformation of conventional molded products when the shape shown in FIG. 1 was used and the thickness and resin material were changed. To facilitate comparison with this embodiment, the conditions except for the mold material were set to be equal to those of this embodiment shown in FIG. 20.

FIG. 19 shows that the amount of warp deformation caused by the shrinkage amount difference was as large as 2.5 mm or more regardless of the material and the thickness difference. Especially when POM by which the thick portion was 10 times as thick as the thin portion or more was used, the warp deformation amount was as large as 5 mm or more. The differences between the types of resins were that crystalline POM and PA6 exhibited large values.

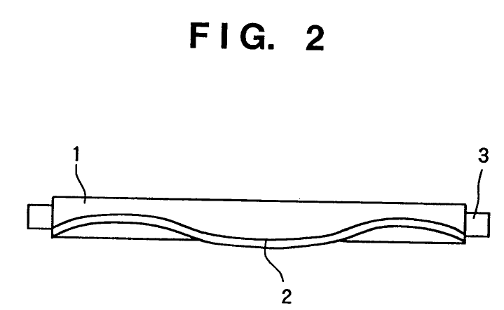

FIG. 2 is a view showing a largely warped molded product in the direction of the end face of a thin portion. Since the shrinkage amount of a thick portion 1 is larger than that of a thin portion 2, warp deformation like a wave occurred as shown in FIG. 2 at the end portion of the thin portion.

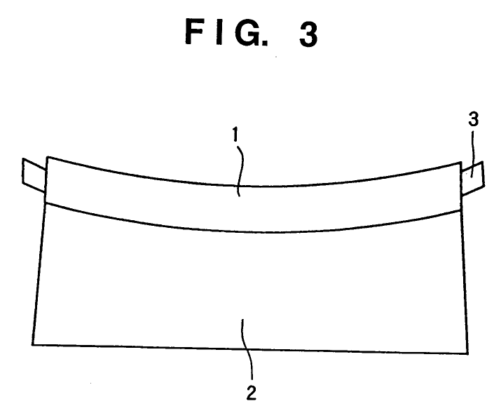

FIG. 3 shows the state in which a deformed product is viewed from above. A thick portion 1 causes warp deformation in the vertical direction of paper by the shrinkage amount difference.

FIG. 20 shows the first example of this embodiment. On the basis of the first characteristic feature of this embodiment, an inert gas as a foaming material was allowed to permeate into each of the same resin materials as shown in FIG. 19, and each resin material was injection-molded for a charging time of 1 sec or less into a metal mold at a temperature lower by 5° C. to 25° C. than the heat deformation temperature of the resin material, thereby letting the resin material foam in the mold. FIG. 20 shows the warp amount of each molded product extracted from the mold. Comparison with the conventional method shown in FIG. 19 demonstrates that this example had an effect of reducing warp in all the resin materials.

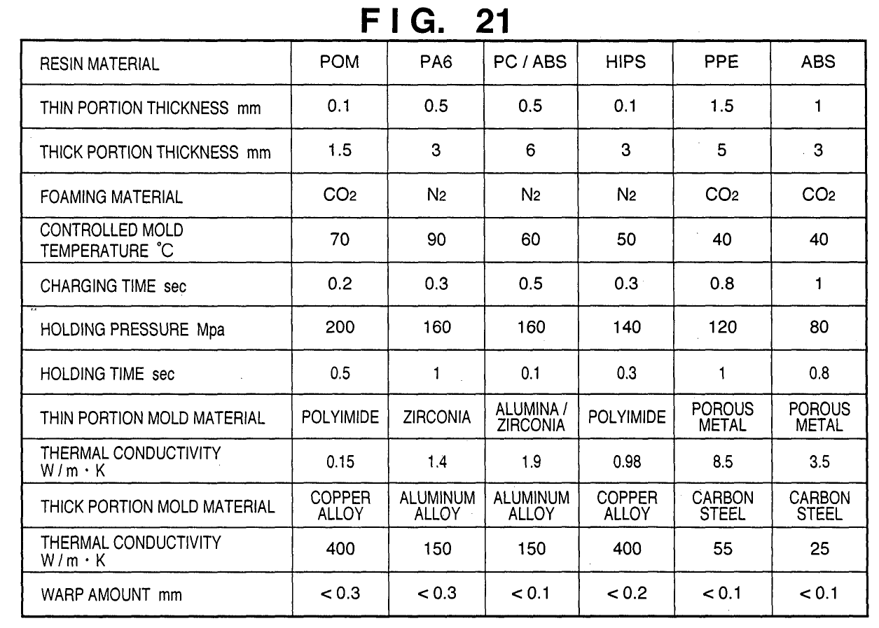

FIG. 21 shows the second example of this embodiment. On the basis of the first characteristic feature of this embodiment, a foaming material was allowed to saturate into each of the same resin materials as shown in FIG. 19, and the resin material was charged at high speed. In addition, on the basis of the second characteristic feature, materials different in thermal conductivity were used as a thin portion and thick portion. Furthermore, on the basis of the third characteristic feature, a holding pressure was applied for a short time period. The warp deformation amounts of the obtained molded products are compared in FIG. 21.

The warp amounts shown in FIG. 21 reveal that this example achieved warp amounts of 0.3 mm or less even for crystalline resin materials, and achieved warp amounts of 0.1 mm or less, i.e., almost eliminated warp deformation for other resin materials.

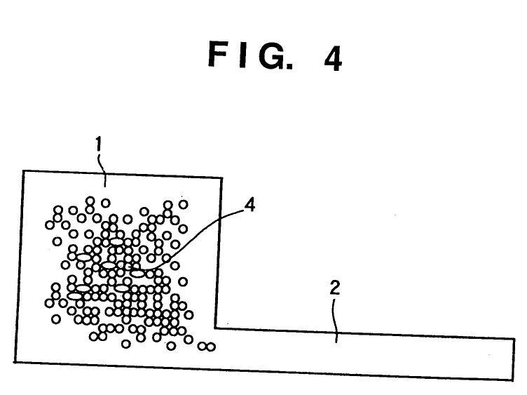

FIG. 4 shows the section of the part shown in FIG. 1 of this embodiment. In the thick portion 1, numberless fine air bubbles of 1 mm or less are formed. In the thin portion 2, almost no such air bubbles are formed.

FIG. 5 shows a metal mold using materials different in thermal conductivity for a thin portion and thick portion, on the basis of the second characteristic feature of this embodiment. Reference numeral 5 denotes a mold piece corresponding to the thick portion; and 6, a mold piece corresponding to the thin portion.

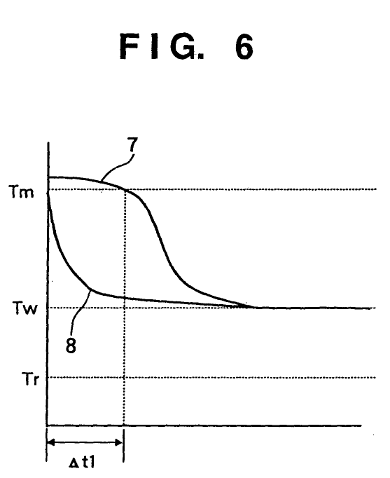

FIG. 6 shows the state in which the thick portion and thin portion of the conventional molded product shown in FIG. 19 were cooled in the mold.

Referring to FIG. 6, the abscissa indicates the time, and the ordinate indicates the temperature. Reference symbol Tm denotes the softening temperature of a resin; Tw, the mold temperature; and Tr, room temperature. Reference numeral 7 denotes the average temperature of the thick portion; and 8, the average temperature of the thin portion. Also, [symbol] t1 denotes the time difference between the thick portion and the thin portion when they were cooled to the softening point of a resin.

As shown in FIG. 6, in the conventional molded product, a large cooling rate difference was produced between the thick portion and thin portion.

The reason why a shrinkage amount difference which is a cause of warp deformation is produced between a thick portion and a thin portion will be explained below with reference to FIG. 6.

Referring to FIG. 6, the thin portion temperature 8 becomes the resin softening temperature Tm or less immediately after the resin is charged into the mold. Since the resin is a solid at the temperature Tm or less, the resin shrinks by a heat shrinkage amount corresponding to the thermal expansion coefficient. However, a crystalline resin shrinks by crystallization down to temperatures close to the room temperature Tr. The surface layer of the thick portion shows a temperature change similar to that of the thin portion immediately after the surface layer comes in contact with the mold. However, as indicated by the curve 7 in FIG. 6, a central portion of this thick portion requires the time [symbol] t1 before reaching the softening temperature. As a consequence, while the thin portion is hardened, the thick portion largely shrinks from the softened state to a solid over the time [symbol] t1. This shrinkage difference of the time [symbol] t1 is a large cause of warp deformation. After passing the softening temperature, the thick portion also shrinks like the thin portion by a heat shrinkage amount corresponding to the thermal expansion coefficient. However, the shrinkage difference of [symbol] t1 remains, and this difference causes warp deformation as the thick portion pulls the thin portion when the molded product is extracted from the mold.

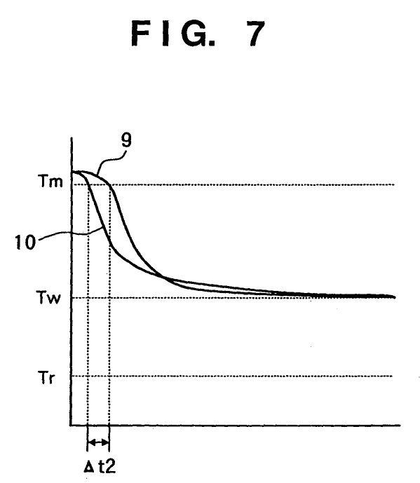

FIG. 7 shows changes in temperatures of the thick portion and thin portion in the mold according to this embodiment.

Referring to FIG. 7, the abscissa indicates the time, and the ordinate indicates the temperature. Reference symbol Tm denotes the softening temperature of a resin; Tw, the mold temperature; and Tr, room temperature. Reference numeral 9 denotes the average temperature of the thick portion; and 10, the average temperature of the thin portion. Also, [symbol] t2 denotes the time difference between the thick portion and the thin portion when they were cooled to the softening point of a resin.

As shown in FIG. 7, it is readily understood that, in this embodiment, the cooling rate difference between the thick portion and the thin portion is much smaller than the [symbol] t1 of the conventional molded product shown in FIG. 6. Accordingly, that shrinkage difference of [symbol] t2 between the thick portion and thin portion, which causes warp deformation as described above becomes very small. Since this difference is small, the force by which the thick portion pulls the thin portion when the molded product is extracted from the mold also decreases. This decreases warp and deformation.

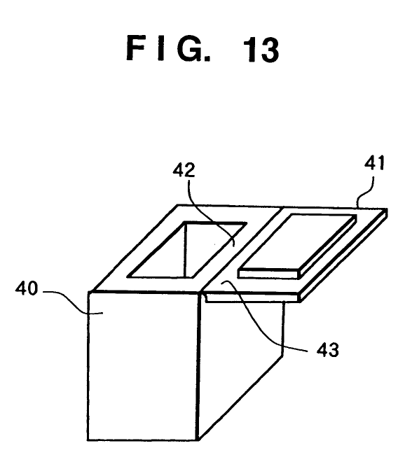

FIG. 13 shows the shape of a molded product of the second example of this embodiment. Reference numeral 40 denotes a resin vessel; 41, a lid; 42, a thick portion; and 43, a thin portion. Since the thin portion 43 functions as a hinge, the lid 41 can be opened and closed. A shrinkage difference is produced between the thick portion 42 and the thin portions 41 and 43. Therefore, a conventional molded product deformed, so the lid 41 could not be accurately fitted on the vessel 40. In contrast, the method of this embodiment extremely decreased this deformation, so the lid could be accurately fitted on the vessel.

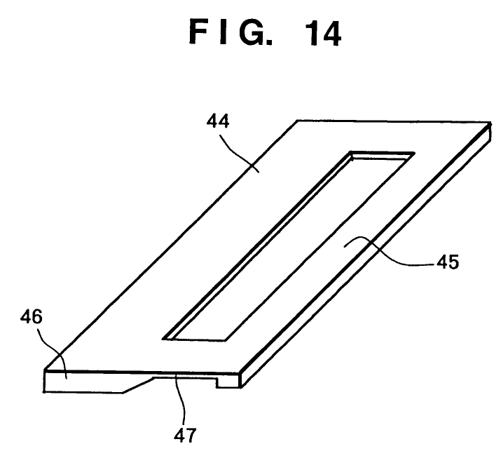

FIG. 14 shows the shape of a molded product of the third example of this embodiment. Reference numeral 44 denotes a molded product main body; 45, a bridge; 46, a thick portion; and 47, a thin portion. When conventional molding was performed, a shrinkage difference was produced between the thick portion 46 and the thin portion 47. Consequently, the molded product deformed, and desired planar precision was difficult to obtain. In contrast, the method of this embodiment extremely decreased this deformation, so high planar precision was obtained.

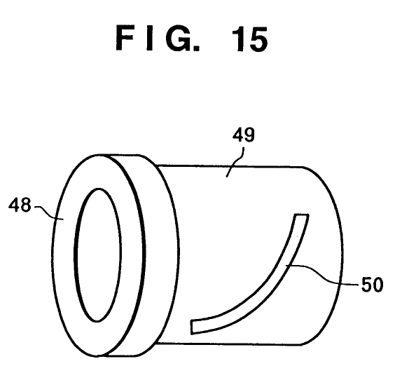

FIG. 15 shows the shape of a lens barrel as a molded product of the fourth example of this embodiment. Reference numeral 48 denotes a thick portion; 49, a thin portion; and 50, a cam. In a conventional molded product, shrinkage of the thick portion was larger than that of the thin portion. This produced a difference between the individual inner diameters to worsen the roundness, and made it difficult to maintain assembly space with other parts. In contrast, when this embodiment was performed, foaming occurred inside the thick portion to decrease the shrinkage difference between this thick portion and the thin portion. This improved the inner diameter precision, and facilitated maintaining space with other parts. Note that a material obtained by mixing 35% of glass fibers in polycarbonate was used as the resin material, and carbon dioxide was used as the gas. As the mold materials, a copper alloy was used for the thick portion, and zirconia ceramic was used for the thin portion. The injection charging time was 0.1 sec, and a holding pressure of 18 Mpa was applied for 1 sec.

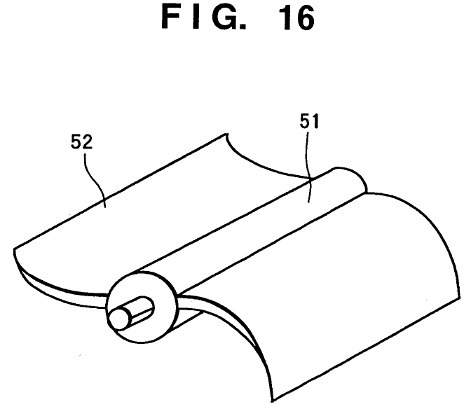

FIG. 16 is a view showing a fan which is a molded product of the fifth example of this embodiment, and is used in an air conditioner or the like. Reference numeral 51 denotes a thick portion which also functions as a mounting shaft; and 52, thin portions as blades. In a conventional molded product, shrinkage of the thick portion was larger than that of the thin portions, so the end portions of the blades 52 deformed. In contrast, in this embodiment, a foaming agent was allowed to saturate into a resin material beforehand, and foam molding was performed. Since foaming occurred inside the thick portion, the shrinkage difference from the thin portions decreased. This decreased the deformation at the ends of the blades 52. In addition, as mold materials described in this embodiment, an aluminum alloy was used for the thick portion, and a polyimide deposition polymerization layer and chromium coating layer were used for the thin portions. When molding was performed for an injection charging time of 0.5 sec by applying a holding pressure of 10 Mpa for 0.5 sec, the deformation of the blades 52 almost completely disappeared. Note that an acrylonitrilebutadiene resin was used as the resin material, and carbon dioxide was used as the gas.

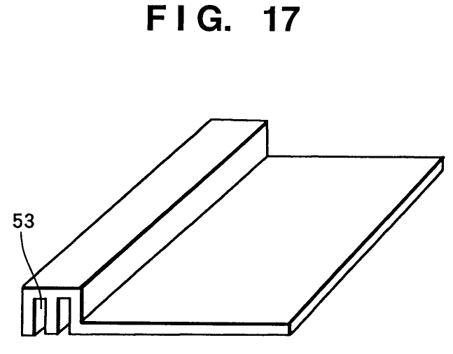

FIG. 17 shows the shape of a conventional molded product having a thick portion in which recesses 53 are formed.

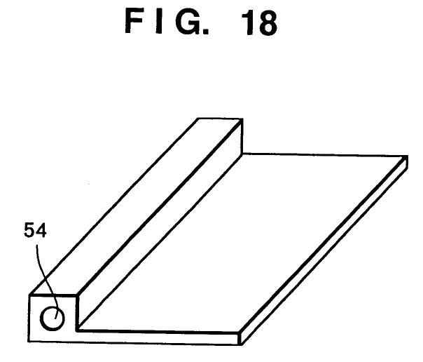

FIG. 18 shows the shape of another conventional molded product. Reference numeral 54 denotes a sink continuously formed inside a thick portion in the axial direction by a gas.

As described above, warp deformation caused by the shrinkage difference between a thick portion and thin portion of a resin-molded product having a large thickness difference can be decreased very much by using one or more of the characteristic features of this embodiment, i.e., by allowing a foaming material to saturate into a resin material, by injecting the resin material into a mold within a short time period, by applying a predetermined holding pressure for a short time period, and/or by using mold materials different in thermal conductivity for a thin portion and thick portion.

As has been explained above, the above embodiment can prevent warp and deformation caused by a shrinkage difference when a resin part having a large thickness difference is molded.

As many apparently widely different embodiments of the present invention can be made without departing from the spirit and scope thereof, it is to be understood that the invention is not limited to the specific embodiments thereof except as defined in the appended claims.

What is claimed is:

1. A resin-molded product having a thick portion and thin portion, wherein the thick portion is a foamed body.

2. The product according to claim 1, wherein the thick portion is a rod, and the thin portion is a plate.

3. The product according to claim 1, wherein the thick portion is a ring, and the thin portion is a cylinder.

4. A resin-molded product preparing method of preparing a resin-molded product having a thick portion and thin portion, wherein
after an inert gas is allowed to saturate into a resin material, the resin material is injected, for a injection time of not more than 1 sec, into a metal mold at a temperature lower by 5° C. to 25° C. than a heat deformation temperature of the resin material before the inert gas saturates, and the resin material is extracted from the mold after being foamed and hardened in the mold.

5. A resin-molded product preparing method of preparing a resin-molded product having a thick portion and thin portion, wherein
after an inert gas is allowed to saturate into a resin material, the resin material is injected into a metal mold in which a mold portion for molding the thin portion has a thermal conductivity of 0.15 to 8.5 W/m·K, and the resin material is molded in the metal mold.

6. The method according to claim 5, wherein the mold portion for molding the thin portion is made up of a resin layer having a thermal conductivity of 0.15 to 0.98 W/m·K at room temperature, and a hard coat layer.

7. The method according to claim 6, wherein the resin layer is a polyimide layer formed by vapor deposition polymerization and having a thickness of 0.05 to 0.5 mm.

8. The method according to claim 5, wherein the mold portion for molding the thin portion is made of a ceramic having a thermal conductivity of 1.4 to 1.9 W/m·K at room temperature.

9. The method according to claim 5, wherein the mold portion for molding the thin portion is made of a porous metal having a thermal conductivity of 3.5 to 8.5 W/m·K at room temperature.

10. The method according to claim 5, wherein a mold portion for molding the thick portion is made of a copper alloy or aluminum alloy having a thermal conductivity of 150 to 400 W/m·K at room temperature.

11. The method according to claim 5, wherein a mold portion for molding the thick portion is made of carbon steel having a thermal conductivity of 25 to 55 W/m·K at room temperature.

12. A resin-molded product preparing method of preparing a resin-molded product having a thick portion and thin portion, wherein
after an inert gas is allowed to saturate into a resin material, the resin material is injected into a metal mold, and a holding pressure of 80 to 200 Mpa is applied for 0.1 to 1 sec.
